(19) United States
(12) Patent Application Publication
(10) Pub. No.: US 2011/0026420 A1
(43) Pub. Date: Feb. 3, 2011

(54) LAYER SHIFTING FOR UPLINK MIMO

(75) Inventors: Xiaoxia Zhang, San Diego, CA (US); Tao Luo, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/840,147

(22) Filed: Jul. 20, 2010

Related U.S. Application Data
(60) Provisional application No. 61/230,664, filed on Jul. 31, 2009.

(51) Int. Cl. H04L 12/26; H04W 40/00

(52) U.S. Cl. 370/252; 370/328

(57) ABSTRACT

Wireless communications methods and related apparatuses are provided. The methods include analyzing a report or a channel quality indicator in a multiple-in-multiple-out (MIMO) wireless communications system. In one aspect, the methods include determining whether layer shifting should be employed in view of the report or channel quality indicator. The methods also include enabling or disabling layer shifting in an uplink communication based on the report or the channel quality indicator.

### CROSS-REFERENCE TO RELATED APPLICATION

This application claims priority pursuant to 35 U.S.C. §119(e) to U.S. provisional application Ser. No. 61/230,664, filed Jul. 31, 2009, and entitled “METHODS OF LAYER SHIFTING FOR UPLINK MIMO,” the entirety of which is incorporated herein by reference.

### BACKGROUND

I. Field

The following description relates generally to wireless communications systems, and more particularly to methods for layer shifting in multiple-in-multiple-out (MIMO) systems.

II. Background

Wireless communication systems are widely deployed to provide various types of communication content such as voice, data, and so forth. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems including E-UTRA, and orthogonal frequency division multiple access (OFDMA) systems. The technology described herein pertains to these and similar systems.

An orthogonal frequency division multiplex (OFDM) communication system effectively partitions the overall system bandwidth into multiple (N_{F}) subcarriers, which may also be referred to as frequency sub-channels, tones, or frequency bins. For an OFDM system, the data to be transmitted (i.e., the information bits) is first encoded with a particular coding scheme to generate coded bits, and the coded bits are further grouped into multi-bit symbols that are then mapped to modulation symbols. Each modulation symbol corresponds to a point in a signal constellation defined by a particular modulation scheme (e.g., M-PSK or M-QAM) used for data transmission. At each time interval that may be dependent on the bandwidth of each frequency subcarrier, a modulation symbol may be transmitted on each of the N_{F} frequency subcarrier. Thus, OFDM may be used to combat inter-symbol interference (ISI) caused by frequency selective fading, which is characterized by different amounts of attenuation across the system bandwidth.

Generally, a wireless multiple-access communication system can concurrently support communication for multiple wireless terminals that communicate with one or more base stations via transmissions on forward and reverse links. The forward link (or downlink) refers to the communication link from the base stations to the access terminals, and the reverse link (or uplink) refers to the communication link from the access terminals to the base stations. This communication link may be established via a single-in-single-out, multiple-in-signal-out or a multiple-in-multiple-out (MIMO) system.

A MIMO system employs multiple (N_{T}) transmit antennas and multiple (NR) receive antennas for data transmission. A MIMO channel formed by the N_{T} transmit and N_{R} receive antennas may be decomposed into N_{S} independent channels, which are also referred to as spatial channels. Generally, each of the N_{S} independent channels corresponds to a dimension. The MIMO system can provide improved performance (e.g., higher throughput and/or greater reliability) if the additional dimensionalities created by the multiple transmit and receive antennas are utilized. A MIMO system also supports time division duplex (TDD) and frequency division duplex (FDD) systems. In a TDD system, the forward and reverse link transmissions are on the same frequency region so that the reciprocity principle allows estimation of the forward link channel from the reverse link channel. This enables an access point to transmit beam-forming gain on the forward link when multiple antennas are available at the access point.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

Methods and systems provide layer shifting options for multiple-in-multiple-out (MIMO) wireless communications systems. In an aspect, a method for wireless communications is provided. The method includes analyzing channel quality indicators for respective layers of a multiple-in-multiple-out (MIMO) wireless communications system; and determining a configuration for an uplink communication based at least in part on the channel quality indicators, wherein the configuration comprises one of a layer shifting enabled mode and a layer shifting disabled mode.

In another aspect, a method for wireless communications is provided. The method includes determining, using a report from a user equipment (UE) in a multiple-in-multiple-out (MIMO) wireless communications system, whether UE employs different power amplification (PA) for different ones of multiple antennas; and configuring layer shifting for an uplink communication based at least in part on the determination.

In yet another aspect, an apparatus for wireless communications is provided. The apparatus includes a memory that retains instructions for analyzing channel quality indicators for respective layers of a multiple-in-multiple-out (MIMO) wireless communications system, and for determining a configuration for an uplink communication based at least in part on the channel quality indicators, wherein the configuration comprises one of a layer shifting enabled mode and a layer shifting disabled mode; and a processor that executes the instructions.

In another aspect, an apparatus for wireless communications is provided. The apparatus includes a memory that retains instructions for determining, using a report from a user equipment (UE) in a multiple-in-multiple-out (MIMO) wireless communications system, whether the UE employs different power amplification (PA) for different ones of multiple antennas, and instructions for configuring layer shifting for an uplink communication based at least in part on the determination; and a processor that executes the instructions.

In another aspect, an apparatus for wireless communications is provided. The apparatus includes means for analyzing channel quality indicators for respective channels of a multiple-in-multiple-out (MIMO) wireless communications system; and means for determining a configuration for an uplink communication based at least in part on the channel quality indicators, wherein the configuration comprises one of a layer shifting enabled mode and a layer shifting disabled mode.

In another aspect, an apparatus for wireless communications is provided. The apparatus includes means for determining, using a report from a user equipment (UE) in a multiple-in-multiple-out (MIMO) wireless communications system, whether the UE employs different power amplification (PA) for different ones of multiple antennas; and means for configuring layer shifting for an uplink communication based at least in part on the determination.

In still another aspect, a computer program product is provided. The computer program product includes a computer-readable storage medium holding coded instructions configured to cause a processor to: analyze channel quality indicators for respective layers of a multiple-in-multiple-out (MIMO) wireless communications system; and determine a configuration for an uplink communication based at least in part on the channel quality indicators, wherein the configuration comprises one of a layer shifting enabled mode and a layer shifting disabled mode.

In another aspect, a computer program product is provided. The computer program product includes a computer-readable storage medium holding coded instructions configured to cause a processor to: determine, using a report from a user equipment (UE) in a multiple-in-multiple-out (MIMO) wireless communications system, whether the UE employs different power amplification (PA) for different ones of multiple antennas; and configure layer shifting for an uplink communication based at least in part on the determination.

In one aspect, a user equipment (UE) is configured for layer shifted or non-layer shifted MIMO uplink channels. Thus, a base station or evolved Node B (eNB) configures the UE in layer shifting mode or non-layer shifting mode based on a user equipment category report in one example. For example, if the UE has a different power amplifier (PA) class on different transmit (Tx) antennas, the eNB configures the UE in non-layer shifting mode; otherwise, the UE is configured in layer shifting mode. The configuration may be signaled from the eNB via higher layer signaling. In the alternative, or in addition, the UE may be configured by a predetermined one-to-one mapping without using a configuration signal from the eNB. For example, if the access terminal has different PA classes for different Tx antennas, no layer shifting is configured; otherwise, layer shifting is configured.

In the alternative, or in addition, the eNB configures the UE in layer shifting mode or non-layer shifting mode based on the estimated channels/CQIs (channel quality indicators). The eNB estimates the channel/CQI per layer where for frequency division duplex (FDD), the system employs a sounding reference signal (SRS) and for time division duplex (TDD), the system employs SRS or channel reciprocity. If estimated channels/CQIs over multiple layers have strong imbalance, the eNB can perform power control per transmit antenna to bring the received signal-to-noise ratio (SNR) per layer to be close to each other and thus configure the UE with layer shifting. In another option, the system configures the UE in non-layer shifting mode. If estimated channels/CQIs over multiple layers are close to each other, the system configures UE in layer shifting mode.

Configuration of the layer shifting mode can be semi-static or dynamic. Semi-static configuration may be implemented using higher layer signaling from the base station to the UE. Dynamic configuration may be implemented using a physical downlink control channel (PDCCH), where the base station adds a bit in the uplink (UL) grant to indicate to the UE to switch on layer shifting mode or not. In the alternative, or in addition, the state of cyclic redundancy checking (CRC) masking or scrambling can be used by the base station to indicate to the UE that layer shifting is on or off.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 illustrates a high level block diagram of a system that employs layer shifting in a wireless communications system.

FIG. 2 illustrates an example communications apparatus that employs layer shifting.

FIG. 3 illustrates a multiple access wireless communication system.

FIGS. 4 and 5 illustrate example communications systems that can be employed with layer shifting.

FIGS. 6 and 7 illustrate an exemplary wireless method and system, respectively.

FIG. 8 illustrates aspects of an uplink transmission between a base station and an access terminal using MIMO in a wireless communications system.

FIGS. 9A and 9B illustrate conceptual aspects of layer shifting in a wireless communications system.

FIGS. 10 and 11 illustrate an exemplary wireless method and system, respectively that include setting a communication mode in response to channel quality indicators.

FIGS. 12 and 13 illustrate an exemplary wireless method and system, respectively, that include setting a communication mode in response to a user equipment category report.

### DETAILED DESCRIPTION

Systems and methods are provided to enable layer shifting options for uplink communications on multiple-in-multiple-out (MIMO) systems. In one aspect, a wireless communications method is provided. The method includes analyzing a quality report or a channel quality indicator in a multiple-in-multiple-out wireless communications system. This includes determining whether layer shifting should be employed in view of the quality report or channel quality indicator. The method also includes enabling or disabling the layer shifting in an uplink communication based on the quality report or the channel quality indicator.

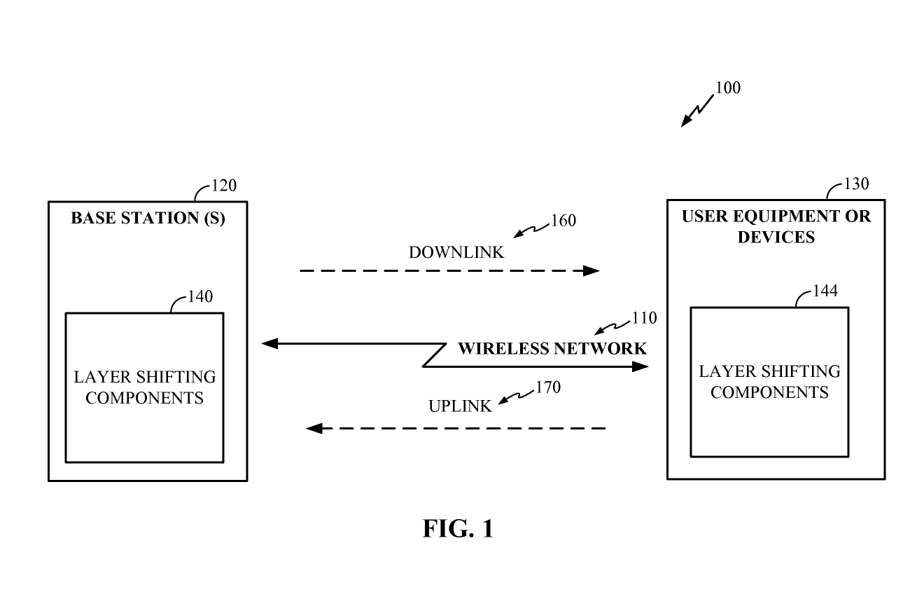

Referring now to FIG. 1, a system 100 employs layer shifting components in a wireless network 110. The system 100 includes one or more base stations 120 (also referred to as a node, evolved node B (eNB), serving eNB, target eNB, femto station, pico station) which can be an entity capable of communication over the wireless network 110 to various devices 130. For instance, each device 130 can be an access terminal (AT) (also referred to as terminal, user equipment (UE), mobility management entity (MME) or mobile device). The base station 120 and device 130 can include a layer shifting component 140 and 144 respectively. It is to be appreciated that layer shifting may occur between base stations, between base stations and devices, and/or between base stations, devices, and other network components such as a network manager or server. As shown, the base station 120 communicates to the device 130 (or devices) via downlink 160 and receives data via uplink 170. Such designation as uplink and downlink is arbitrary as the device 130 can also transmit data via downlink and receive data via uplink channels. It is noted that although two components 120 and 130 are shown, that more than two components can be employed on the network 110, where such additional components can also be adapted for reference signal coordination herein.

Multi-codeword transmissions can be provided in the uplink (UL). To extend the peak rate in the UL, various options can be provided. In one option, layer shifting with ACK/NACK bundling can be provided, where a single physical hybrid automatic repeat request indicator channel (PHICH) is employed to acknowledge (ACK) or no-acknowledge (NACK) multiple codewords. Performance degradation may be observed with large antenna gain imbalance (AGI).

When no layer shifting is selected and multiple PHICHs are employed, each codeword has a separate ACK/NACK (e.g., larger PHICH overhead). There is generally no performance degradation with large AGI. Generally, layer shifting requires less PHICH overhead but may result into performance loss with strong AGI, whereas no layer shifting requires more PHICH overhead but no performance loss. As will be described in more detail below, the eNB or base station 120 can automatically configure the access terminal 130 either in layer shifted or non-layer shifted mode.

The system 100 provides layer shifting options for multiple-in-multiple-out (MIMO) wireless communications systems. In one aspect, an access terminal is configured to process layer shifted or non-layer shifted MIMO uplink channels. Thus, a base station or eNB configures an access terminal in layer shifting mode or non-layer shifting mode based on a user equipment category report in one example. If the category report indicates that the access terminal has a different power amplifier (PA) class on different transmit (Tx) antennas, the eNB configures the access terminal in non-layer shifting mode—otherwise, the access terminal is configured in layer shifting mode. The configuration is via higher layer signaling or may be a one-to-one mapping, e.g., if the access terminal has a different PA class, no layer shifting is configured, otherwise, layer shifting is configured.

In another option, the eNB configures access terminal in layer shifting mode or non-layer shifting mode based on estimated CQIs (channel quality indicators) for each channel. The eNB estimates the CQI per layer where for frequency division duplex (FDD), the system employs a sounding reference signal (SRS) and for time division duplex (TDD), the system employs SRS or channel reciprocity. If estimated CQIs over multiple layers have strong imbalance, the eNB can perform power control per Tx antenna to bring the received signal-to-noise ratio (SNR) per layer to be close to each other (e.g., close determined by threshold) and thus configure the access terminal with layer shifting. In another option, the system configures the access terminal in non-layer shifting mode. If estimated CQIs over multiple layers are close to each other, the system configures access terminal in layer shifting mode.

Configuration of the layer shifting or no-layer shifting mode can be semi-static or dynamic. Semi-static configuration is via higher layer signaling. Dynamic configuration can be via a physical downlink control channel (PDCCH), where adding a bit in the uplink (UL) grant to indicate to the access terminal to switch on layer shifting mode or not. Cyclic redundancy checking (CRC) masking or scrambling can be employed to indicate that layer shifting is on or off It is noted that the system 100 can be employed with an access terminal or mobile device, and can be, for instance, a module such as an SD card, a network card, a wireless network card, a computer (including laptops, desktops, personal digital assistants PDAs), mobile phones, smart phones, or any other suitable terminal that can be utilized to access a network. The terminal accesses the network by way of an access component (not shown). In one example, a connection between the terminal and the access components may be wireless in nature, in which access components may be the base station and the mobile device is a wireless terminal. For instance, the terminal and base stations may communicate by way of any suitable wireless protocol, including but not limited to Time Divisional Multiple Access (TDMA), Code Division Multiple Access (CDMA), Frequency Division Multiple Access (FDMA), Orthogonal Frequency Division Multiplexing (OFDM), FLASH OFDM, Orthogonal Frequency Division Multiple Access (OFDMA), or any other suitable protocol.

Access components can be an access node associated with a wired network or a wireless network. To that end, access components can be, for instance, a router, a switch, or the like. The access component can include one or more interfaces, e.g., communication modules, for communicating with other network nodes. Additionally, the access component can be a base station (or wireless access point) in a cellular type network, wherein base stations (or wireless access points) are utilized to provide wireless coverage areas to a plurality of subscribers. Such base stations (or wireless access points) can be arranged to provide contiguous areas of coverage to one or more cellular phones and/or other wireless terminals.

The techniques described herein may be implemented by various means. For example, these techniques may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in memory unit and executed by the processors.

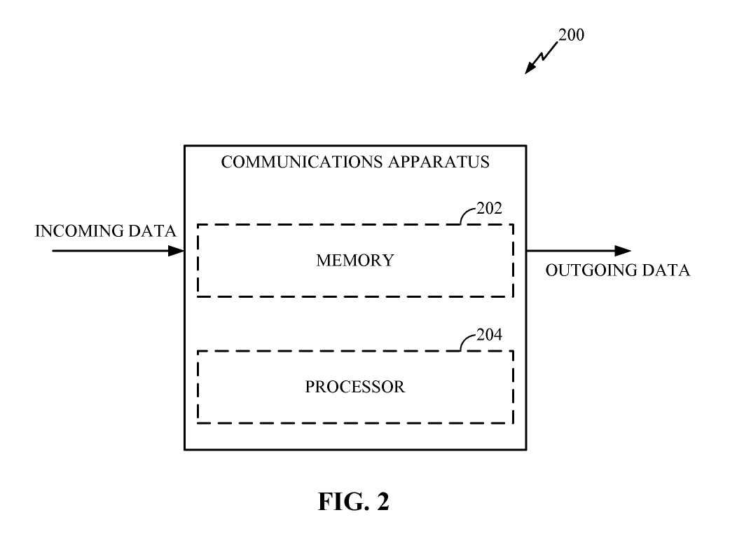

FIG. 2 illustrates a communications apparatus 200 that can be a wireless communications apparatus, for instance, such as a wireless terminal. Additionally or alternatively, communications apparatus 200 may reside within a wired network. Communications apparatus 200 can include memory 202 that can retain instructions for performing a signal analysis in a wireless communications terminal. Additionally, communications apparatus 200 may include a processor 204 that can execute instructions within memory 202 and/or instructions received from another network device, wherein the instructions can relate to configuring or operating the communications apparatus 200 or a related communications apparatus.

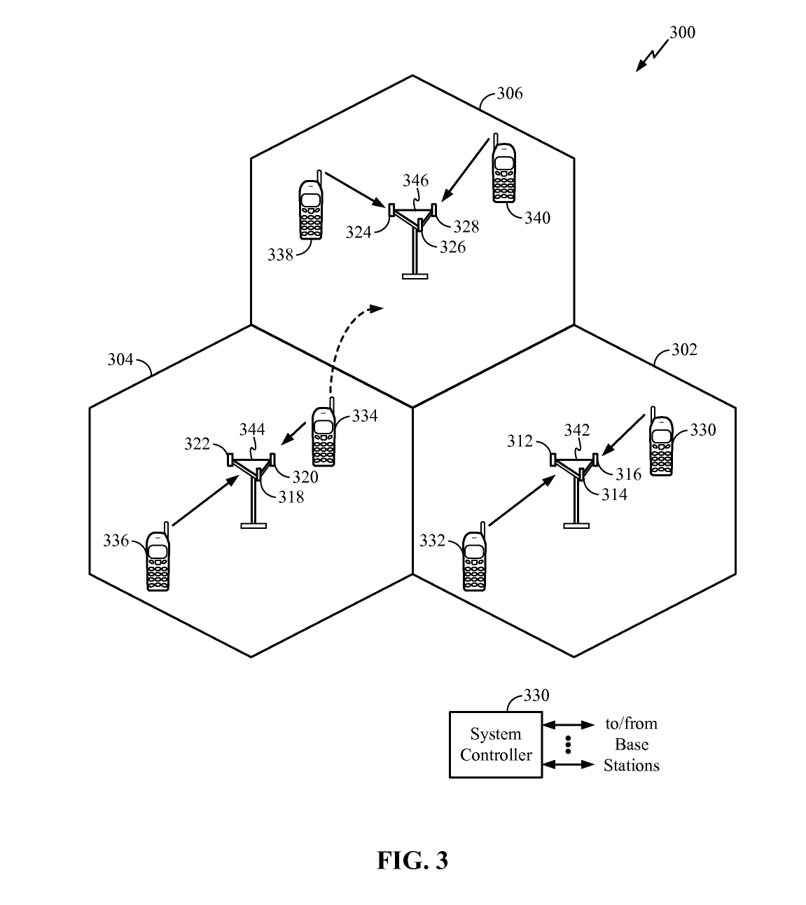

Referring to FIG. 3, a multiple access wireless communication system 300 is illustrated. The multiple access wireless communication system 300 includes multiple cells, including cells 302, 304, and 306. In the aspect the system 300, the cells 302, 304, and 306 may include a Node B that includes multiple sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 can include several wireless communication devices, e.g., Access Terminals (ATs), which can be in communication with one or more sectors of each cell 302, 304 or 306. For example, ATs 330 and 332 can be in communication with Node B 342, ATs 334 and 336 can be in communication with Node B 344, and ATs 338 and 340 can be in communication with Node B 346.

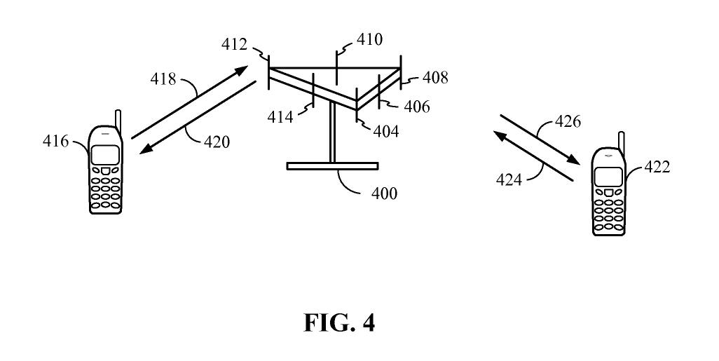

Referring now to FIG. 4, a multiple access wireless communication system according to one aspect is illustrated. An access point 400 (AP) includes multiple antenna groups, one including 404 and 406, another including 408 and 410, and an additional including 412 and 414. In FIG. 4, only two antennas are shown for each antenna group, however, more or fewer antennas may be utilized for each antenna group. Access terminal 416 (AT) is in communication with antennas 412 and 414, where antennas 412 and 414 transmit information to access terminal 416 over forward link 420 and receive information from access terminal 416 over reverse link 418. Access terminal 422 is in communication with antennas 406 and 408, where antennas 406 and 408 transmit information to access terminal 422 over forward link 426 and receive information from access terminal 422 over reverse link 424. In a FDD system, communication links 418, 420, 424 and 426 may use different frequencies for communication. For example, forward link 420 may use a different frequency then that used by reverse link 418.

Each group of antennas and/or the area in which they are designed to communicate is often referred to as a sector of the access point. Antenna groups each are designed to communicate to access terminals in a sector, of the areas covered by access point 400. In communication over forward links 420 and 426, the transmitting antennas of access point 400 may utilize beam-forming in order to improve the signal-to-noise ratio of forward links for the different access terminals 416 and 424. Also, an access point using beam-forming to transmit to access terminals scattered randomly through its coverage causes less interference to access terminals in neighboring cells than an access point transmitting through a single antenna to all its access terminals. An access point may be a fixed station used for communicating with the terminals and may also be referred to as an access point, a Node B, evolved Node B (eNB), or some other terminology. An access terminal may also be called a user equipment (UE), a wireless communication device, terminal, mobile device, or some other terminology.

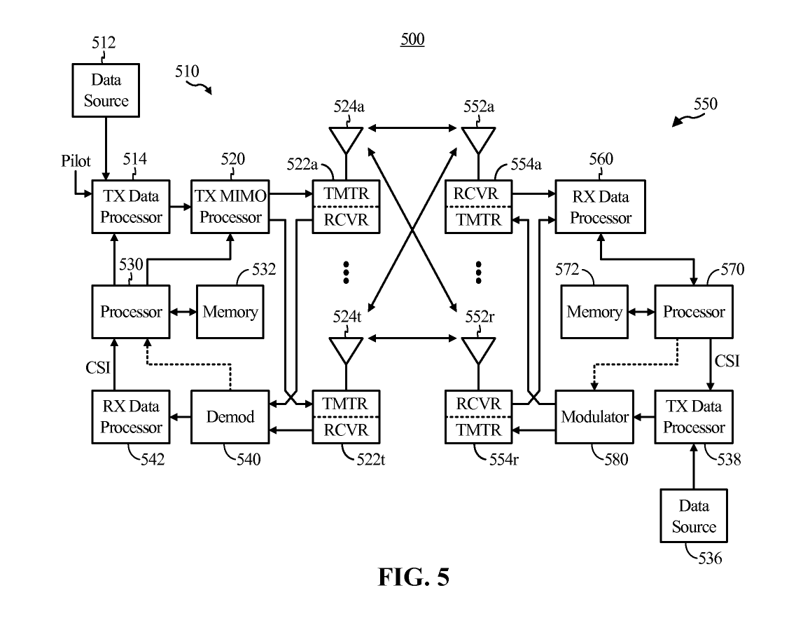

Referring to FIG. 5, illustrated is a system 500 that includes a transmitter system 510 (also known as an access point or base station) and a receiver system 550 (also known as an access terminal or user equipment). At the transmitter system 510, traffic data for a number of data streams is provided from a data source 512 to a transmit (TX) data processor 514. Each data stream is transmitted over a respective transmit antenna. TX data processor 514 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 530.

The modulation symbols for all data streams are then provided to a TX MIMO processor 520, which may further process the modulation symbols (e.g., for OFDM). TX MIMO processor 520 then provides NT modulation symbol streams to NT transmitters (TMTR) 522a through 522t. In certain embodiments, TX MIMO processor 520 applies beam-forming weights to the symbols of the data streams and to the antenna from which the symbol is being transmitted.

Each transmitter 522 receives and processes a respective symbol stream to provide one or more analog signals, and further conditions (e.g., amplifies, filters, and up-converts) the analog signals to provide a modulated signal suitable for transmission over the MIMO channel. NT modulated signals from transmitters 522a through 522t are then transmitted from NT antennas 524a through 524t, respectively.

At the receiver system 550, the transmitted modulated signals are received by NR antennas 552a through 552r and the received signal from each antenna 552 is provided to a respective receiver (RCVR) 554a through 554r. Each receiver 554 conditions (e.g., filters, amplifies, and down-converts) a respective received signal, digitizes the conditioned signal to provide samples, and further processes the samples to provide a corresponding “received” symbol stream.

An RX data processor 560 then receives and processes the NR received symbol streams from NR receivers 554 based on a particular receiver processing technique to provide NT “detected” symbol streams. The RX data processor 560 then demodulates, de-interleaves, and decodes each detected symbol stream to recover the traffic data for the data stream. The processing by RX data processor 560 is complementary to that performed by TX MIMO processor 520 and TX data processor 514 at transmitter system 510.

A processor 570 periodically determines which pre-coding matrix to use (discussed below). Processor 570 formulates a reverse link message comprising a matrix index portion and a rank value portion. The reverse link message may comprise various types of information regarding the communication link and/or the received data stream. The reverse link message is then processed by a TX data processor 538, which also receives traffic data for a number of data streams from a data source 536, modulated by a modulator 580, conditioned by transmitters 554a through 554r, and transmitted back to transmitter system 510.

At the transmitter system 510, the modulated signals from receiver system 550 are received by antennas 524, conditioned by receivers 522, demodulated by a demodulator 540, and processed by a RX data processor 542 to extract the reverse link message transmitted by the receiver system 550. Processor 530 then determines which pre-coding matrix to use for determining the beam-forming weights, then processes the extracted message.

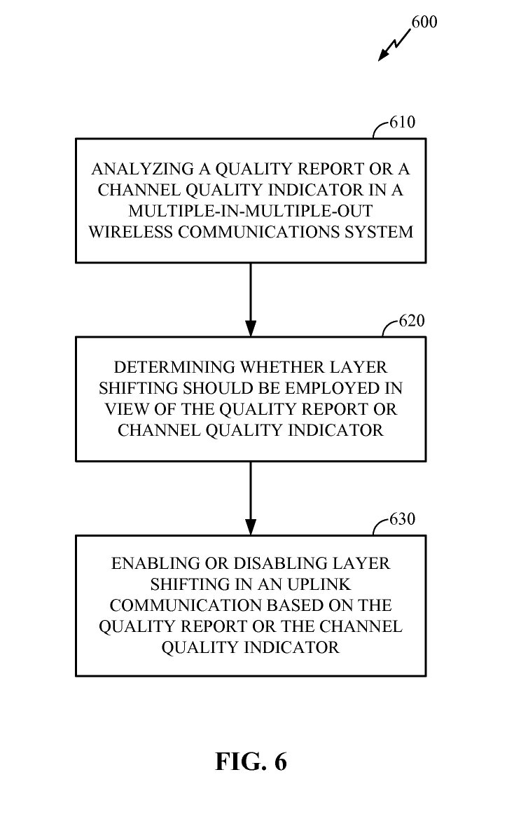

Referring now to FIG. 6, a wireless communications methodology is illustrated. While, for purposes of simplicity of explanation, the methodology (and other methodologies described herein) are shown and described as a series of acts, it is to be understood and appreciated that the methodology is not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be utilized to implement a methodology in accordance with the claimed subject matter.

At 610, the method 600 includes analyzing a quality report or a channel quality indicator in a multiple-in-multiple-out wireless communications system. At 620, the method 600 includes determining whether layer shifting should be employed in view of the quality report or channel quality indicator. At 630, the method includes enabling or disabling layer shifting in an uplink communication based on the quality report or the channel quality indicator.

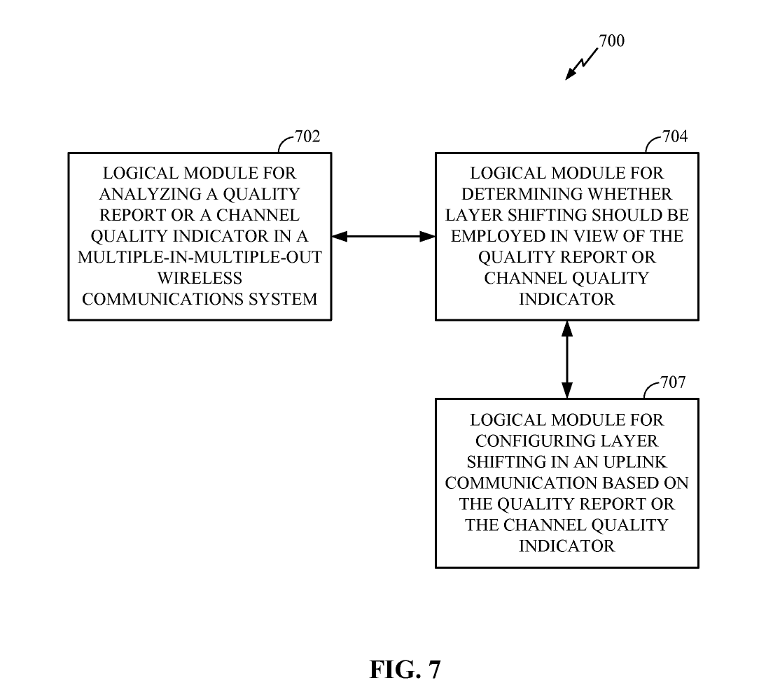

Referring to FIG. 7, a wireless communication system 700 is provided. The system 700 includes a logical module 702 or means for analyzing a quality report or a channel quality indicator in a multiple-in-multiple-out wireless communications system. This includes a logical module 704 or means for determining whether layer shifting should be employed in view of the quality report or channel quality indicator. The system 700 also includes a logical module 706 or means for configuring layer shifting in an uplink communication based on the quality report or the channel quality indicator.

In another aspect, a communications apparatus is provided. The apparatus includes a memory that retains instructions for analyzing a quality report or a channel quality indicator in a multiple-in-multiple-out wireless communications system, determining whether layer shifting should be employed in view of the quality report or channel quality indicator, and enabling or disabling layer shifting in an uplink communication based on the quality report or the channel quality indicator; and a processor that executes the instructions.

In another aspect, a computer program product is provided. The computer program product includes a computer-readable medium that includes code for causing a computer to analyze a quality report or a channel quality indicator in a multiple-in-multiple-out wireless communications system; code for causing a computer to determine whether layer shifting should be employed in view of the quality report or channel quality indicator; and code for causing a computer to configure layer shifting in an uplink communication based on the quality report or the channel quality indicator.

In another aspect, a processor is provided that executes the following instructions, the instructions for: analyzing a quality report or a channel quality indicator in a multiple-in-multiple-out wireless communications system; determining whether layer shifting should be employed in view of the quality report or channel quality indicator; an automatically configuring layer shifting in an uplink communication based on the quality report or the channel quality indicator.

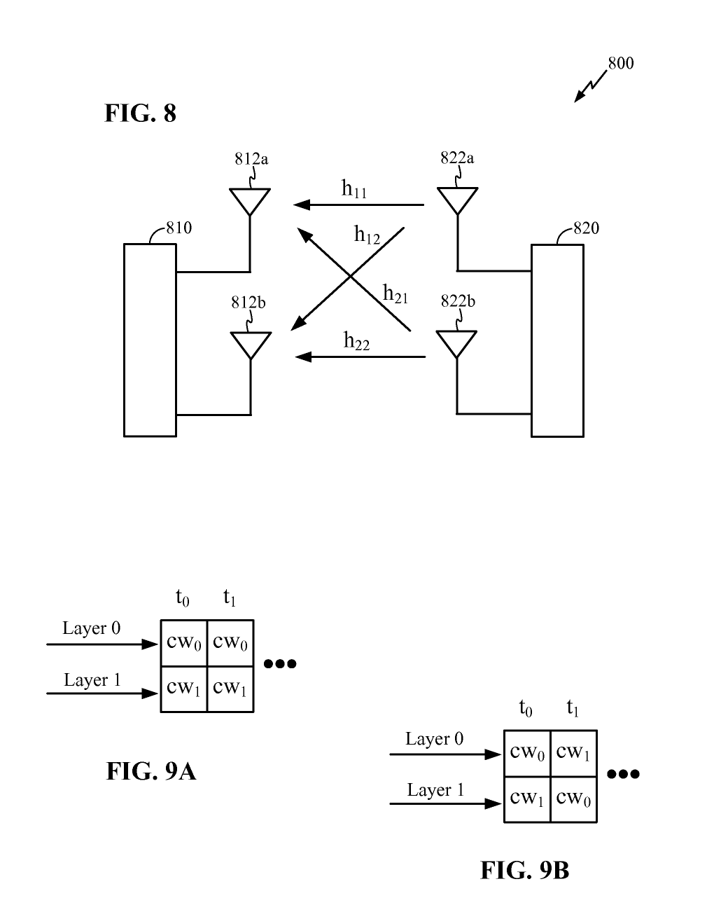

Referring to FIG. 8, aspects of an uplink transmission between a base station 810 and an access terminal 820 using MIMO in a wireless communications system 800 may include a 2×2 MIMO link from two transmit antennas 822a, 822b for the access terminal 820 to two receiving antennas 812a, 812b for the base station 810. The base station 810 and access terminal 820 may be configured as to certain details in accordance with the foregoing disclosure. The MIMO link includes a first spatial channel h₁₁, between antennas 822a and 812a, also called layer h₁₁. The MIMO link also includes a second spatial channel h₂₂ between antennas 822b and 812b, also called layer h₂₂. In addition, cross component h₁₂ occurs between antenna 822a and antenna 812b, and cross component h₂₁ occurs between antennas 822b and 812a.

With reference to FIG. 8, the transmission matrix H for the MIMO link may be defined in some embodiments as

$$[ \begin{matrix}{h}_{11} & {h}_{21} \\ {h}_{12} & {h}_{22}\end{matrix} ] = [ \begin{matrix}{\vec{h}}_{1} & {\vec{h}}_{2}\end{matrix} ] . \qquad ( Eq . 1 )$$

Likewise, the channel quality indicators (CQIs) for channels h₁₁ and h₂₂ may be defined, respectively, as

CQI₁=\vec{h}*₁[HH*+Σ]⁻¹\vec{h}₁ (Eq. 2), and

CQI₂=\vec{h}*₂[HH*+Σ]⁻¹\vec{h}₂ (Eq. 3)

Other algorithms for computing the CQI may also be used, if applicable. An imbalance in channel quality indicators may be used to indicate an antenna gain imbalance (AGI) between transmission channels. A base station may determine the CQI values by measuring the signal-to-noise ratio in each channel via a training sequence and performing computations as indicated above.

With reference to FIGS. 9A and 9B, layer shifting in a wireless communications system using codewords entails shifting codewords between multiple layers of a MIMO link. FIG. 9a illustrates a no layer shifting mode, or layer shifting disabled mode, in which each code word is transmitted in a single layer; for example, codeword cw₀ in layer₀ only and cw₁ in layer₁ only. FIG. 9b illustrates a layer shifting mode, or layer shifting enabled mode, in which each code word is transmitted in multiple layers in a defined sequence; for example, codeword cwₒ in layerₒ and then in layer₁, and codeword cw₁ in layer₁ and then in layer₀.

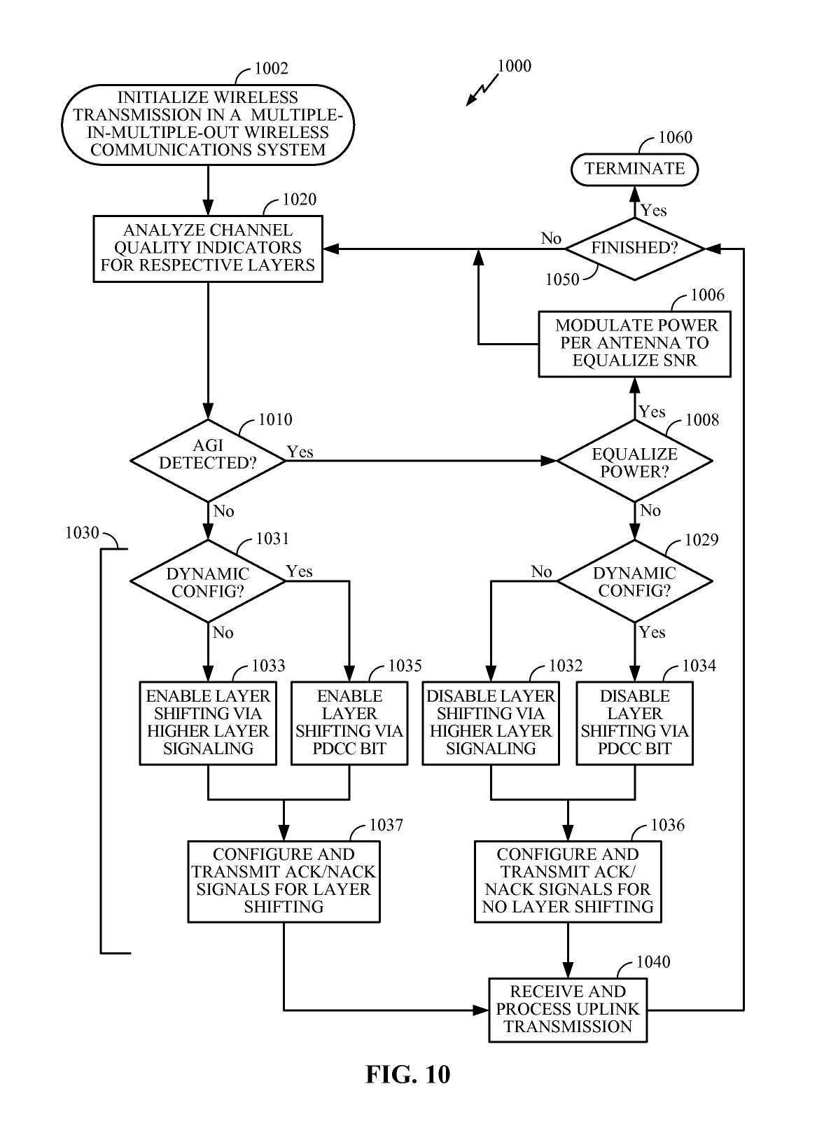

With reference to the forgoing figures and description, a method 1000 for configuring layer shifting in an uplink transmission from an access terminal to a base station may include steps and operations as shown in FIG. 10. At 1002, the base station may initialize a communication session with an access terminal in a MIMO wireless communication system. At 1020, the base station may analyze channel quality indicators (CQIs) for each respective layer of a MIMO system for communicating between the access terminal and the base station.

At 1010, the base station may determine whether or not, in response to the CQI analysis (at 1020), there is an antenna gain imbalance between transmit antennas in the MIMO link. For example, if qualified for 2×2 MIMO transmission, the access terminal may have at least two different transmit antenna, which may exhibit a gain imbalance or gain balance. Distinguishing a gain balanced condition from an imbalanced condition should be related to the degree of antenna gain balance needed to reliably execute a layer shifted transmission. Balance in the present disclosure does not necessarily mean perfect equality in antenna gain; instead, it means that any inequality in antenna gain is not large enough to cause significant errors or data loss in a layer shifted transmission.

Optionally, as indicated at branch 1008, the base station may transmit a signal to the access terminal, instructing the access terminal to modulate power delivered per MIMO transmit antenna 1006, so as to equalize the signal-to-noise ratio (SNR) between the uplink channels. The base station may measure the SNR in the uplink channels and provide feedback information to the access terminal to facilitate SNR equalization. However, if the access terminal is not equipped to perform power modulation per antenna in response to a signal from the base station, step 1006 cannot be performed.

The steps generally indicated at 1030 may be included in configuring layer shifting for an uplink communication between an access terminal and the base station, to a mode selected from layer shifting enabled or layer shifting disabled, in response to analyzing the channel quality indicators. At 1029 and parallel step 1031, the base station may determine whether or not to configure the layer shifting mode in a semi-static configuration, or in a dynamic configuration. Both configurations may involve signaling to the access terminal, with more frequent signaling used in the dynamic configuration. The choice between semi-static and dynamic configuration need not be implemented as a process step in method 1000. Instead, the choice may be predetermined by design; for example, the base station may always operate in semi-static configuration, or always operate in dynamic configuration, depending on its initial configuration and design.

At 1033, if a semi-static configuration is to be used, the base station may enable layer shifting via higher layer signaling to the access terminal, for example, using a radio resource control (RRC) layer. In the present disclosure, “semi-static configuration” means the layer shifting mode is changed or reset at intervals of about 100 ms, or longer. At 1035, if a dynamic configuration is to be used, the base station may enable layer shifting via signaling to the access terminal using a bit, for example, the uplink grant bit, in the physical downlink control channel (PDCCH). In the present disclosure, “dynamic configuration” means the layer shifting mode is changed or reset at intervals of less than about 100 ms. At 1037, the base station may configure and transmit ACK/NACK signals consistent with layer shifting. For example, the base station may transmit multiple codewords over each PHICH using ACK/NACK bundling, wherein a single PHICH is used to acknowledge (ACK) or no-acknowledge (NACK) multiple codewords. In other words, the base station may configure the ACK/NACK signals as one signal per multiple codewords from the base station to the access terminal, in response to layer shifting being in an enabled mode.

At 1032, if a semi-static configuration is to be used, the base station may disable layer shifting via higher layer signaling to the access terminal. At 1034, if a dynamic configuration is to be used, the base station may disable layer shifting by signaling to the access terminal using a bit, for example, the uplink grant bit, in the PDCCH. At 1036, the base station may configure and transmit ACK/NACK signals consistent with no layer shifting, i.e., layer shifting disabled. For example, the base station may transmit each codeword using separate PHICHs. The base station may therefore use each PHICH to acknowledge (ACK) or no-acknowledge (NACK) each codeword. In other words, the base station may configure the ACK/NACK signals as one signal per codeword from the base station to the access terminal, in response to layer shifting being in a disabled mode.

At 1040, the base station may receive and process the uplink transmission using one or more wireless communication processes and processors as described herein until the wireless communication session is finished 1050 and then terminate the session 1060, or continue with the uplink if not finished. Configuration of the layer shifting may therefore change in a dynamic or semi-static configuration during the wireless communication session with the access terminal.

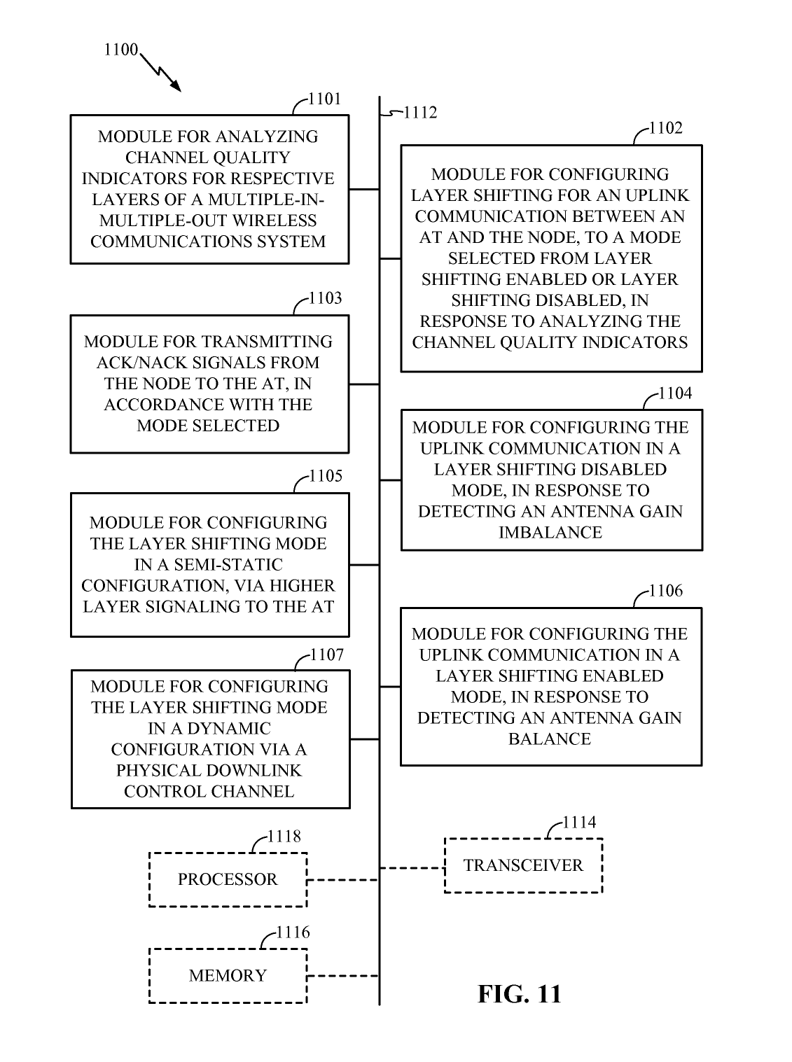

Consistent with method 1000, and as further illustrated by FIG. 11, an apparatus 1100 may function as a node or base station in a wireless communication system. The apparatus 1100 may comprise an electronic component or module 1101 for analyzing channel quality indicators for respective layers of a multiple-in-multiple-out wireless communications system, for example, as described in connection with method 1000. The apparatus 1100 may comprise an electronic component or module 1102 for configuring layer shifting for an uplink communication between the access terminal and the apparatus 1100, to a mode selected from a layer shifting enabled mode and a layer shifting disabled mode, in response to analyzing the channel quality indicators.

More specifically, the apparatus 1100 may comprise an electronic component or module 1104 for automatically configuring the uplink communication in a layer shifting disabled mode, in response to detecting an antenna gain imbalance using the channel quality indicators. In addition, the apparatus 1100 may comprise an electronic component or module 1106 for automatically configuring the uplink communication in a layer shifting enabled mode, in response to detecting antenna gain balance using the channel quality indicators. Distinguishing a gain balanced condition from an imbalanced condition may be done based on experience with the degree of antenna gain balance needed to reliably execute a layer shifted transmission. Balance in the present disclosure does not require perfect equality in antenna gain; rather, it means that any inequality in antenna gain is not large enough to cause significant errors or data loss in a layer shifted transmission.

The apparatus 1100 may further comprise an electronic component or module 1103 for transmitting acknowledgement or no acknowledgement (ACK/NACK) signals from the apparatus to the access terminal consistent with layer shifting mode selected by module/component 1102. For example, in response to layer shifting disabled mode being selected, module/component 1103 may cause the apparatus 1100 to transmit each code word using separate physical hybrid control channels (PHICHs). The apparatus 1100 therefore uses each PHICH to acknowledge (ACK) or no-acknowledge (NACK) each code word. In other words, the apparatus 1100 may configure the ACK/NACK signals as one signal per codeword from the apparatus to the access terminal, in response to layer shifting being in a disabled mode. In response to layer shifting enabled mode being selected, the module/component 1103 may cause the apparatus to transmit multiple codewords over each PHICH using ACK/NACK bundling, wherein a single PHICH is used to acknowledge (ACK) or no-acknowledge (NACK) multiple codewords. In other words, the apparatus 1100 may configure the ACK/NACK signals as one signal per multiple codewords from the apparatus to the access terminal, in response to layer shifting being in an enabled mode.

The apparatus 1100 may comprise an electronic component or module 1105 for configuring the layer shifting mode for an uplink communication in a semi-static configuration, by transmitting a signal from the apparatus to the access terminal using higher-layer signaling. In addition, apparatus 1100 may comprise an electronic component or module 1107 for configuring the layer shifting mode for an uplink communication in a dynamic configuration, using a bit in a physical downlink control channel (PDCCH). For example, the module 1107 may control the value of a designated bit in the uplink grant to indicate to the access terminal whether or not to uplink transmit in a layer shifting mode.

The apparatus 1100 may optionally include a processor module 1118 having at least one processor; in the case of the apparatus 1100 configured as a communication network entity, rather than as a general purpose microprocessor. The processor 1118, in such case, may be in operative communication with the modules 1101-1107 via a bus 1112 or similar communication coupling. The processor 1118 may effect initiation and scheduling of the processes or functions performed by electrical components 1101-1107.

In related aspects, the apparatus 1100 may include a transceiver module 1114. A stand alone receiver and/or stand alone transmitter may be used in lieu of or in conjunction with the transceiver 1114. In further related aspects, the apparatus 1100 may optionally include a module for storing information, such as, for example, a memory device/module 1116. The computer readable medium or the memory module 1116 may be operatively coupled to the other components of the apparatus 1100 via the bus 1112 or the like. The memory module 1116 may be adapted to store computer readable instructions and data for effecting the processes and behavior of the modules 1101-1107, and subcomponents thereof, or the processor 1318, or the methods disclosed herein, and other operations for wireless communications. The memory module 1116 may retain instructions for executing functions associated with the modules 1101-1107. While shown as being external to the memory 1116, the modules 1101-1107 can include at least portions within the memory 1116.

In further related aspects, the memory 1116 may optionally include executable code for the processor module 1118 and/or ones of the modules 1101-1107 to cause the apparatus 1100 perform a method that comprises the steps of: (a) analyzing channel quality indicators for respective layers of a multiple-in-multiple-out wireless communications system, using a node of the wireless communications system; and (b) configuring layer shifting for an uplink communication between an access terminal and the node, to a mode selected from layer shifting enabled or layer shifting disabled, in response to analyzing the channel quality indicators. For example, the method may comprise configuring the uplink transmission to a layer shifting disabled mode, in response to detecting an antenna gain imbalance using the channel quality indicators. Conversely, for example, the method may comprise configuring the uplink transmission to a layer shifting enabled mode, in response to detecting antenna gain balance using the channel quality indicators.

The method may also comprise instructing the access terminal to modulate power per transmission antenna to equalize per-layer signal-to-noise ratio, in response to detecting an antenna gain imbalance using the channel quality indicators.

The method may comprise configuring acknowledgment/no acknowledgement (ACK/NACK) signals from the node to the access terminal, in accordance with the mode selected from layer shifting enabled or layer shifting disabled. The method may comprise configuring the layer shifting mode in a semi-static configuration, via higher layer signaling to the access terminal. The method may comprise configuring the layer shifting mode in a dynamic configuration, using a bit transmitted to the access terminal via a physical downlink control channel. Similarly, the memory 1116 may optionally include executable code for the processor module 1118 to cause the apparatus 1100 to perform method 1000 as already described in connection with FIG. 10 above.

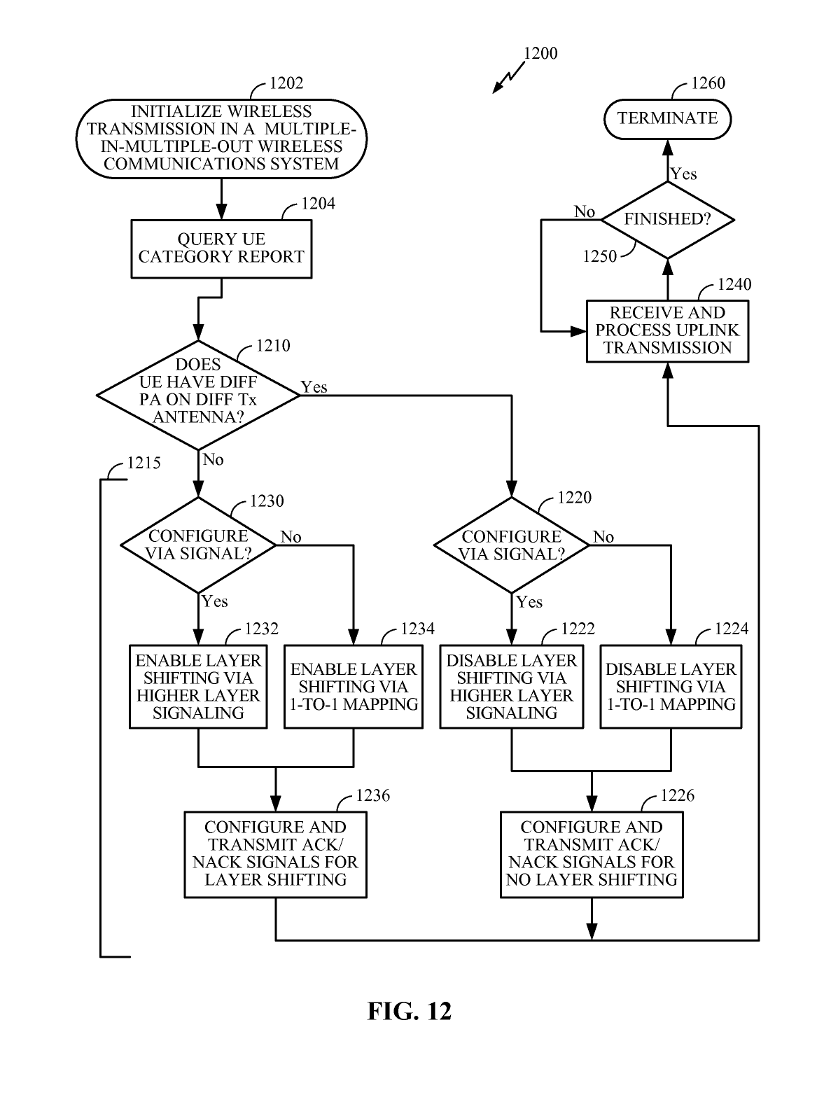

In the alternative, or in addition, a method 1200 for configuring layer shifting in an uplink transmission from an access terminal to a base station may include steps and operations as shown in FIG. 12. At 1202, the base station may initialize a communication session with an access terminal in a MIMO wireless communication system. At 1204, the base station may obtain a user equipment category report for the access terminal, for example, by querying the access terminal and receiving a reply.

At 1210, the base station may determine whether or not the access terminal has different power amplification on different transmit antennas of its MIMO uplink transmission link, using information from the category report. For example, if qualified for 2×2 MIMO transmission, the access terminal may have at least two different transmit antennas, with identical or substantially identical power amplification for both antennas. Conversely, the category report may indicate that the access terminal does not have identical or substantially identical power amplification for both transmit antennas. What constitutes “identical or substantially identical power amplification” may depend on parameters for the specific access terminal and receiving node involved in the transmission. Power amplification from the access terminal should be deemed “not substantially identical” or “different” on different antennas, if it does not result in substantially the same average channel quality for the applicable uplink MIMO spatial channels, as measurable using the receiving base station. Conversely, power amplification from the access terminal should be deemed “substantially identical” or “equivalent” on different antennas, if it results in substantially the same average channel quality for the applicable uplink MIMO spatial channels, as measurable by the receiving base station. For example, if the power amplification is exactly the same for every transmit antenna of the access terminal, the average channel quality at the base station should be substantially, if not exactly, the same. For further example, if power amplification differs by more than 50% (e.g., a threshold) at the access terminal, average channel quality at the base station may often be substantially different. It is understood that other threshold values or some other measurement may be employed to determine whether the power amplification for different transmit antennas are “different” or “substantially different.”

The steps generally indicated at 1215 may be included in configuring layer shifting for an uplink communication from the access terminal to the base station, to a mode selected from layer shifting enabled or layer shifting disabled, in response to determining whether the access terminal has different power amplification for the different ones of multiple transmission antennas. At 1220 and parallel step 1230, the base station may determine whether or not to configure the layer shifting mode using signaling to the access terminal, for example, higher layer signaling. As an alternative to making a determination as illustrated at 1220 or 1230, the manner of configuring layer shifting for the uplink transmission may be predetermined. That is, for example, using signaling to the access terminal may be predetermined for all uplink transmissions to the base station, or alternatively, using 1-to-1 mapping without signaling may be predetermined for all uplink transmissions to the base station.

At 1232, if signaling is to be used and the access terminal does not have different power amplification on different transmit antennas, the base station may enable layer shifting via higher layer signaling to the access terminal. At 1234, if signaling is not to be used and the access terminal does not have different power amplification on different transmit antennas, the base station may enable layer shifting by 1-to-1 mapping without higher layer signaling to the access terminal. At 1236, the base station may configure and transmit ACK/NACK signals consistent with layer shifting. For example, the base station may transmit multiple codewords over each PHICH using ACK/NACK bundling, wherein a single PHICH is used to acknowledge (ACK) or no-acknowledge (NACK) multiple codewords. In other words, the base station may configure the ACK/NACK signals as one signal per multiple codewords from the base station to the AT, in response to layer shifting being in an enabled mode.

At 1222, if signaling is to be used and the access terminal has different power amplification on different transmit antennas, the base station may disable layer shifting via higher layer signaling to the access terminal. At 1224, if signaling is not to be used and the access terminal does has different power amplification on different transmit antennas, the base station may disable layer shifting by 1-to-1 mapping without higher layer signaling to the access terminal. At 1226, the base station may configure and transmit ACK/NACK signals consistent with no layer shifting. For example, the base station may transmit each codeword using separate PHICHs. The base station may therefore use each PHICH to acknowledge (ACK) or no-acknowledge (NACK) each codeword. In other words, the base station may configure the ACK/NACK signals as one signal per codeword from the node to the access terminal, in response to layer shifting being in a disabled mode.

At 1240, the base station may receive and process the uplink transmission using one or more wireless communication processes and processors as described herein until the wireless communication session is finished 1250, or continue with the uplink if not finished. Configuration of the layer shifting may remain static during the wireless communication session with the access terminal.

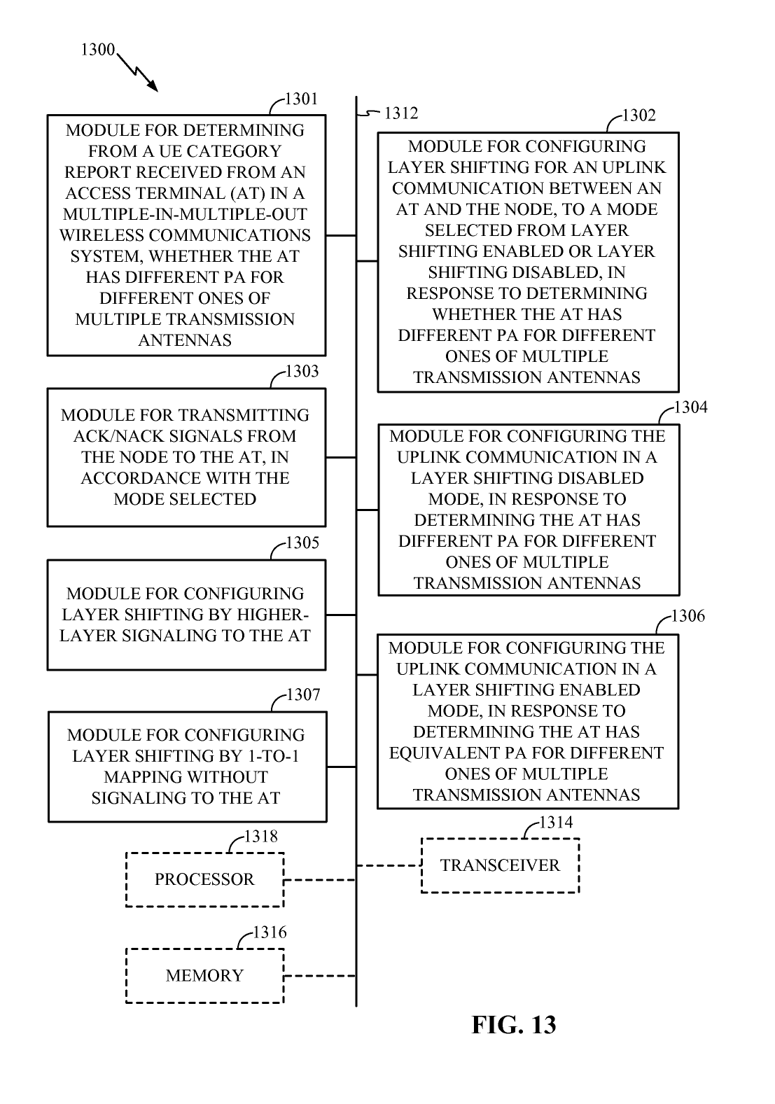

Consistent with method 1200, and as further illustrated by FIG. 13, an apparatus 1300 may function as a node or base station in a wireless communication system. The apparatus 1300 may comprise an electronic component or module 1301 for receiving a user equipment category report from an access terminal in a multiple-in multiple-out (MIMO) wireless communications system, and determining from the category report whether or not the access terminal has different power amplification (PA) for different ones of its multiple transmit antennas used in MIMO communications. The apparatus 1300 may comprise an electronic component or module 1302 for configuring layer shifting for an uplink communication between the access terminal and the apparatus 1300, to a mode selected from a layer shifting enabled mode and a layer shifting disabled mode, in response to determining whether the access terminal has different PA for different ones of its multiple transmit antennas used in MIMO communications.

More specifically, the apparatus 1300 may comprise an electronic component or module 1304 for configuring the uplink communication in a layer shifting disabled mode, in response to determining that the access terminal has different power amplification for different ones of multiple transmit antennas. Similarly, the apparatus 1300 may comprise an electronic component or module 1306 for configuring the uplink communication in a layer shifting enabled mode, in response to determining that the access terminal has equivalent power amplification for different ones of multiple transmit antennas.

The exact meaning of “different power amplification” or “equivalent power amplification” depends on parameters for the specific access terminal and receiving node involved in the transmission. Power amplification from the access terminal should be deemed “different” on different antennas, if it does not result in substantially the same average channel quality for the applicable uplink MIMO spatial channels, as would be measurable by the receiving apparatus 1300. Conversely, power amplification from the access terminal should be deemed “equivalent” on different antennas, if it results in substantially the same average channel quality for the applicable uplink MIMO spatial channels, as would be measurable by the receiving apparatus 1300. For example, if the power amplification is exactly the same for every transmit antenna of the access terminal, the average channel quality at the apparatus 1300 should be substantially, if not exactly, the same. For further example, if power amplification differs by more than 50% at the access terminal, average channel quality at the apparatus 1300 may often be substantially different.

The apparatus 1300 may further comprise an electronic component or module 1303 for transmitting acknowledgement or no acknowledgement (ACK/NACK) signals from the apparatus to the access terminal consistent with layer shifting mode selected by module/component 1302. For example, in response to layer shifting disabled mode being selected, module/component 1303 may cause the apparatus to transmit each codeword using separate physical hybrid control channels (PHICHs). The apparatus therefore uses each PHICH to acknowledge (ACK) or no-acknowledge (NACK) each code word. That is, the apparatus 1300 may configure the ACK/NACK signals as one signal per codeword from the base station to the access terminal, in response to layer shifting being in a disabled mode. In response to layer shifting enabled mode being selected, the module/component 1303 may cause the apparatus to transmit multiple codewords over each PHICH using ACK/NACK bundling, wherein a single PHICH is used to acknowledge (ACK) or no-acknowledge (NACK) multiple codewords. In other words, the apparatus may configure the ACK/NACK signals as one signal per multiple codewords from the base station to the access terminal, in response to layer shifting being in an enabled mode.

The apparatus 1300 may comprise an electronic component or module 1305 for configuring the layer shifting mode for an uplink communication, by transmitting a signal from the apparatus to the access terminal using higher-layer signaling. In the alternative, or in addition, apparatus 1300 may comprise an electronic component or module 1307 for configuring the layer shifting mode for an uplink communication without transmitting a signal from the apparatus to the access terminal, and instead using a predetermined 1-to-1 mapping corresponding to the state of power amplification difference at the access terminal.

The apparatus 1300 may optionally include a processor module 1318 having at least one processor; in the case of the apparatus 1300 configured as a communication network entity, rather than as a general purpose microprocessor. The processor 1318, in such case, may be in operative communication with the modules 1301-1307 via a bus 1312 or similar communication coupling. The processor 1318 may effect initiation and scheduling of the processes or functions performed by electrical components 1301-1307.

In related aspects, the apparatus 1300 may include a transceiver module 1314. A stand alone receiver and/or stand alone transmitter may be used in lieu of or in conjunction with the transceiver 1314. In further related aspects, the apparatus 1300 may optionally include a module for storing information, such as, for example, a memory device/module 1316. The computer readable medium or the memory module 1316 may be operatively coupled to the other components of the apparatus 1300 via the bus 1312 or the like. The memory module 1316 may be adapted to store computer readable instructions and data for effecting the processes and behavior of the modules 1301-1307, and subcomponents thereof, or the processor 1318, or the methods disclosed herein, and other operations for wireless communications. The memory module 1316 may retain instructions for executing functions associated with the modules 1301-1307. While shown as being external to the memory 1316, it is to be understood that the modules 1301-1307 may exist at least partly within the memory 1316.

In further related aspects, the memory 1316 may optionally include executable code for the processor module 1318 and/or ones of the modules 1301-1307 to cause the apparatus 1300 perform a method that comprises the steps of: (a) determining, using a user equipment category report from an access terminal in a multiple-in-multiple-out wireless communications system, whether the access terminal has different power amplification (PA) for different ones of multiple transmission antennas; and (b) configuring layer shifting for an uplink communication from the access terminal to the base station, to a mode selected from layer shifting enabled or layer shifting disabled, in response to determining whether the access terminal has different PA for the different ones of multiple transmission antennas. The method may comprise configuring the access terminal in a layer shifting enabled mode, in response to determining that the access terminal does not have different PA for the different ones of multiple transmission antennas. The method may comprise configuring the access terminal in a layer shifting disabled mode, in response to determining that the access terminal has different PA for the different ones of multiple transmission antennas. The method may comprise configuring the layer shifting mode by higher layer signaling to the access terminal. The method may comprise configuring the layer shifting using predetermined one-to-one mapping between the base station and access terminal, without higher layer or other responsive signaling to the access terminal. Similarly, the memory 1316 may optionally include executable code for the processor module 1318 to cause the apparatus 1300 to perform method 1200 as described in connection with FIG. 12 above.

In an aspect, logical channels of wireless communications may be classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. Logical Traffic Channels comprise a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

Transport Channels are classified into DL and UL. DL Transport Channels comprises a Broadcast Channel (BCH), Downlink Shared Channel (DL-SCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprise a Random Access Channel (RACH), a Request Channel (REQCH), an Uplink Shared Channel (UL-SCH) and plurality of PHY channels. The PHY channels comprise a set of DL channels and UL channels.

The DL PHY channels comprise: Physical Downlink Shared Channel (PDSCH), Physical Broadcast Channel (PBSH), Physical Multicast Channel (PMCH), Physical Downlink Control Channel (PDCCH), Physical Hybrid Automatic Repeat Request Indicator Channel (PHICH), and Physical Control Format Indicator Channel (PCFICH).

The UL PHY Channels comprise: Physical Random Access Channel (PRACH), Physical Uplink Shared Channel (PUSCH), and Physical Uplink Control Channel (PUCCH).

It is noted that various aspects are described herein in connection with a terminal. A terminal can also be referred to as a system, a user equipment, user device, a subscriber unit, subscriber station, mobile station, mobile device, remote station, remote terminal, access terminal, user terminal, user agent, or access terminal. A user device can be a cellular telephone, a cordless telephone, a Session Initiation Protocol (SIP) phone, a wireless local loop (WLL) station, a PDA, a handheld device having wireless connection capability, a module within a terminal, a card that can be attached to or integrated within a host device (e.g., a PCMCIA card) or other processing device connected to a wireless modem.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or medium.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A method for wireless communications, comprising:
analyzing channel quality indicators for respective layers of a multiple-in-multiple-out (MIMO) wireless communications system; and
determining a configuration for an uplink communication based at least in part on the channel quality indicators, wherein the configuration comprises one of a layer shifting enabled mode and a layer shifting disabled mode.

2. The method of claim 1, further comprising:
detecting an antenna gain imbalance using the channel quality indicators; and
instructing a user equipment (UE) to modulate power per transmission antenna to equalize per-layer signal-to-noise ratio.

3. The method of claim 1, further comprising detecting an antenna gain imbalance using the channel quality indicators;
wherein the determining the configuration comprises selecting the layer shifting disabled mode.

4. The method of claim 1, further comprising detecting an antenna gain balance using the channel quality indicators;
wherein the determining the configuration comprises selecting the layer shifting enabled mode.

5. The method of claim 1, further comprising transmitting an acknowledgment/no acknowledgement (ACK/NACK) signal to a user equipment (UE);
wherein the ACK/NACK signal is transmitted as one signal per codeword if the configuration is determined to be the layer shifting disabled mode;
wherein the ACK/NAC signal is transmitted as one signal per multiple codewords if the configuration is determined to be the layer shifting enabled mode.

6. The method of claim 1, further comprising implementing the configuration for the uplink communication in a semi-static configuration, via higher layer signaling to a user equipment (UE).

7. The method of claim 1, further comprising implementing the configuration for the uplink communication in a dynamic configuration using an indicator transmitted to a user equipment (UE) via a physical downlink control channel.

8. An apparatus for wireless communications, comprising:
a memory that retains instructions for analyzing channel quality indicators for respective layers of a multiple-in-multiple-out (MIMO) wireless communications system, and for determining a configuration for an uplink communication based at least in part on the channel quality indicators, wherein the configuration comprises one of a layer shifting enabled mode and a layer shifting disabled mode; and
a processor that executes the instructions.

9. The apparatus of claim 8, wherein the memory further retains instructions for detecting an antenna gain imbalance using the channel quality indicators, and for signaling a user equipment (UE) to modulate power per transmission antenna to equalize per-layer signal-to-noise ratio.

10. The apparatus of claim 8, wherein the memory further retains instructions for detecting an antenna gain imbalance using the channel quality indicators, and wherein the instructions for determining configuration comprise instructions for selecting the layer shifting disabled mode.

11. The apparatus of claim 8, wherein the memory further retains instructions for detecting an antenna gain balance using the channel quality indicators, and wherein the instructions for determining the configuration comprise instructions for selecting the layer shifting enabled mode.

12. The apparatus of claim 8, wherein the memory further retains instructions for transmitting an acknowledgement/no acknowledgement (ACK/NACK) signal to a user equipment (UE), wherein the ACK/NACK signal is transmitted as one signal per codeword if the configuration is determined to be the layer shifting disabled mode, and wherein the ACK/NACK signal is transmitted as one signal per multiple codewords if the configuration is determined to be the layer shifting enabled mode.

13. The apparatus of claim 8, wherein the memory further retains instructions for implementing the configuration in a semi-static configuration, via higher layer signaling to a user equipment (UE).

14. The apparatus of claim 8, wherein the memory further retains instructions for implementing the configuration in a dynamic configuration using an indicator transmitted to a user equipment (UE) via a physical downlink control channel.

15. An apparatus for wireless communications, comprising:
means for analyzing channel quality indicators for respective channels of a multiple-in-multiple-out (MIMO) wireless communications system; and
means for determining a configuration for an uplink communication based at least in part on the channel quality indicators, wherein the configuration comprises one of a layer shifting enabled mode and a layer shifting disabled mode.

16. The apparatus of claim 15, further comprising means for implementing the configuration in a semi-static configuration, via higher layer signaling to a user equipment (UE).

17. The apparatus of claim 15, further comprising means for implementing the configuration in a dynamic configuration using an indicator transmitted to a user equipment (UE) via a physical downlink control channel.

18. The apparatus of claim 15, further comprising means for detecting an antenna gain balance using the channel quality indicators;
wherein the means for determining the configuration comprise means for selecting the layer shifting enabled mode.

19. The apparatus of claim 15, further comprising means for detecting an antenna gain imbalance using the channel quality indicators;
wherein the means for determining the configuration comprise means for selecting the layer shifting disabled mode.

20. A computer program product comprising a computer-readable storage medium holding coded instructions configured to cause a processor to:
analyze channel quality indicators for respective layers of a multiple-in-multiple-out (MIMO) wireless communications system; and
determine a configuration for an uplink communication based at least in part on the channel quality indicators, wherein the configuration comprises one of a layer shifting enabled mode and a layer shifting disabled mode.

21. The computer product of claim 20, wherein the computer-readable storage medium further holds instructions for implementing the configuration in a semi-static configuration, via higher layer signaling to a user equipment.

22. The computer product of claim 20, wherein the computer-readable storage medium further holds instructions for implementing the configuration in a dynamic configuration using an indicator transmitted to a user equipment (UE) via a physical downlink control channel.

23. A method for wireless communications, comprising:
determining, using a report from a user equipment (UE) in a multiple-in-multiple-out (MIMO) wireless communications system, whether UE employs different power amplification (PA) for different ones of multiple antennas; and
configuring layer shifting for an uplink communication based at least in part on the determination.

24. The method of claim 23, wherein the configuring comprises enabling layer shifting for the uplink communication, in response to the determination that the UE does not employ different PA for different ones of multiple antennas.

25. The method of claim 23, wherein the configuring comprises disabling layer shifting for the uplink communication, in response to the determination that the UE employs different PA for different ones of multiple antennas.

26. The method of claim 23, wherein the configuring comprises configuring layer shifting by higher layer signaling to the UE.

27. The method of claim 23, wherein the configuring comprises configuring layer shifting by using a predetermined one-to-one mapping between the UE and a base station.

28. An apparatus for wireless communications, comprising:
a memory that retains instructions for determining, using a report from a user equipment (UE) in a multiple-in-multiple-out (MIMO) wireless communications system, whether the UE employs different power amplification (PA) for different ones of multiple antennas, and instructions for configuring layer shifting for an uplink communication based at least in part on the determination; and
a processor that executes the instructions.

29. The apparatus of claim 28, wherein the memory retains further instructions for enabling layer shifting for the uplink communication, in response to the determination that the UE does not employ different PA for different ones of multiple antennas;
wherein the memory retains further instructions for disabling layer shifting for the uplink communication, in response to the determination that the UE employs different PA for different ones of multiple antennas.

30. The apparatus of claim 28, wherein the memory retains further instructions for configuring the layer shifting by higher layer signaling to the UE.

31. The apparatus of claim 28, wherein the memory retains further instructions for configuring the layer shifting by using a predetermined one-to-one mapping between the UE and a base station.

32. An apparatus for wireless communications, comprising:
means for determining, using a report from a user equipment (UE) in a multiple-in-multiple-out (MIMO) wireless communications system, whether the UE employs different power amplification (PA) for different ones of multiple antennas; and
means for configuring layer shifting for an uplink communication based at least in part on the determination.

33. The apparatus of claim 32, wherein the means for configuring comprise means for configuring the layer shifting mode by higher layer signaling to the UE.

34. The apparatus of claim 32, further comprising means for configuring the layer shifting using predetermined one-to-one mapping between the UE and a base station.

35. The apparatus of claim 32, wherein the means for configuring the layer shifting comprise means for enabling layer shifting for the uplink communication, in response to the determination that the UE does not employ different PA for different ones of multiple antennas;
wherein the means for configuring the layer shifting comprise means for disabling layer shifting for the uplink communication, in response to the determination that the UE employs different PA for different ones of multiple antennas.

36. A computer program product comprising a computer-readable storage medium holding coded instructions configured to cause a processor to:
determine, using a report from a user equipment (UE) in a multiple-in-multiple-out (MIMO) wireless communications system, whether the UE employs different power amplification (PA) for different ones of multiple antennas; and
configuring layer shifting for an uplink communication based at least in part on the determination.

37. The computer product of claim 36, wherein the computer-readable storage medium holds further instructions for configuring the layer shifting by higher layer signaling to the UE.

38. The computer product of claim 36, wherein the computer-readable storage medium holds further instructions for configuring the layer shifting by using predetermined one-to-one mapping between the UE and a base station.
